(19) United States
(12) Patent Application Publication
(10) Pub. No.: US 2009/0227304 A1
(43) Pub. Date: Sep. 10, 2009

(54) GAMING SYSTEM ENABLING TO BET ON ANY TEAM FORMED WITH A PREDETERMINED NUMBER OF CHARACTERS, GAMING MACHINE AND GAME CONTROL METHOD

(75) Inventor: Fumiya ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/236,008

(22) Filed: Sep. 23, 2008

Related U.S. Application Data
(60) Provisional application No. 61/034,393, filed on Mar. 6, 2008.

(51) Int. Cl. A63F 9/24; A63F 13/00

(52) U.S. Cl. 463/6; 463/25

(57) ABSTRACT

In a racing game, a main control unit 112 of a main controller accepts bets on teams of a predetermined number of characters, in addition to bets on characters participating in each race, from a plurality of terminal devices 30. The main control unit 112 determines ranges of a finishing order, to be processed by processing for determining ranking of teams. Then, after the end of a race, the main control unit 112 provides scores to characters having finished within the range of the finishing order, calculates payouts for bets on teams, regarding teams of which members thereof all have finished within the range of the finishing order, and provides awards.

### CROSS REFERENCE TO RELATED APPLICATIONS

This application claims benefit of U.S. Provisional Application No. 61/034,393, filed Mar. 6, 2008, the entire contents of which are incorporated herein by reference.

### BACKGROUND OF THE INVENTION

1. Field of the Invention

The present invention relates to a gaming system, a gaming machine and a game control method that forms a team of a predetermined number of characters on which a player can bet, in a racing game in which a plurality of characters race for an finishing order.

2. Related Art

Conventionally, racing games are known in which a plurality of characters races, a player bets by predicting the finishing order, and the player is awarded based on the rank of the bet character and an odds announced before the start of the race. A representative example of such racing games is a game in which the racing character is a horse, such as in the horse racing game disclosed in U.S. Pat. No. 5,320,351. The racing character can be a car, other animals and the like; however, the player bets similarly by predicting the finishing order thereof.

The target of a bet can be, in a horse racing game such as the one illustrated in U.S. Pat. No. 6,848,991: a horse of first place; horses of first and second places; a group of a predetermined number of horses including horses of first and second places; and the like. Thus, almost all horse racing games are the same as horse racing of the real world.

In such a case, the ability of a certain character often determines winning and losing, as well as a bet result. For example, in a case where an individual character is configured to be “strong”, the individual character is likely to win the race. Betting on the “strong” individual character can make the probability of winning high; however, the odds thereof becomes low due to a high number of bets thereon, which results in a low payout. Therefore, to earn a high payout, a player must bet on an individual character having a lower probability of winning, and wait for it to win. On the contrary, in a case where all the characters are configured to have the same ability, it is extremely difficult to predict and win the bet due to a lack of clues, which may deter the players.

In order to solve the aforementioned problem, the present invention provides a gaming system, a gaming machine and a game control method in which a player can, in addition to bet based on a certain individual among a plurality of characters participating in a race, bet on a team constituted of a predetermined number of characters, thus providing a various betting options and increasing the chance to win a bet, to arouse the interest and excitement of the player.

### SUMMARY OF THE INVENTION

In a first aspect of the present invention, a gaming system includes: a display for displaying images related to a racing game in which a plurality of characters, which is a target of a bet, races; first memory for storing a plurality of teams constituted of a predetermined plurality of characters; a plurality of terminals including an input device for accepting a designation of the teams as a target of a bet from a plurality of the teams stored in the first memory, and a predetermined bet amount; second memory for storing a designated bet target team and the bet amount for each of the plurality of terminals; and a controller for executing the racing game, in which the controller executes the following processing of: (a) receiving the bet target team and the bet amount from the plurality of terminals and storing thereof, for each of the plurality of terminals, in the second memory; (b) after the end of a race, providing a score, corresponding to a predetermined range of a finishing order from a predetermined finishing order to a second predetermined finishing order, to each of the plurality of characters; (c) determining whether the plurality of characters, to which the score is provided, correspond to members constituting any one of the plurality of teams, and whether all the members are characters to which the score is provided; (d) accumulating the score provided in the processing (b), for each of the teams wherein all the members thereof are characters to which the score is provided; (e) determining a ranking of the plurality of teams based on a sum total of the score obtained in the processing (d); and (f) providing an award based on the ranking of the plurality of teams.

In the first aspect of the present invention, a controller of the gaming system has stored teams constituted of a predetermined number of characters in the first memory, which can be selected as a target of a bet by a player using the input device. After receiving the bets from the plurality of terminals, the controller stores the bet kind and the bet amount in the second memory. Then the controller executes a race and tallies the result thereof. In other words, the controller provides a score, corresponding to a range from a predetermined finishing order to another predetermined finishing order, to each of the plurality of characters. Therefore, a score is provided only to the characters having finished within a predetermined range of finishing order, from a predetermined finishing order to another finishing order. Then the controller determines a team to which the character, to which a score is provided, belongs and determines if all the members of the bet target teams are the characters to which a score is provided. Then, the controller accumulates the score of teams including only members having a score, determines the ranking of the teams based on the accumulated score, and provides award depending on the bet kind and the bet amount made by each of the plurality of terminals, based on at least any one of the ranking of each of the plurality of characters and the ranking of each of the plurality of teams.

In a second aspect of the present invention, a gaming system includes: a display for displaying images related to a racing game in which a plurality of characters, which is a target of a bet, races; first memory for storing a plurality of teams constituted of a predetermined plurality of characters; a plurality of terminals including an input device for accepting a designation of at least any one of: a character as a target of a bet from the plurality of characters; and a team as a target of a bet from the plurality of teams stored in the first memory, and a predetermined bet amount; second memory for storing at least any one of the character and the team designated to be the target of the bet, and the bet amount for each of the plurality of terminals; third memory for storing a range table defining a plurality of ranges of a finishing order to which a score, corresponding to the finishing order in a race, is provided; and a controller for executing the racing game, in which the controller executes the following processing of: (a) determining the range of the finishing order to be applied to a race to be executed based on the range table stored in the third memory, and displaying thereof on the display; (b) receiving at least any one of the character and the team as a target of a bet, and the bet amount from the plurality of terminals and storing thereof in the second memory; (c) after the end of a race, providing a score to characters having finished within the range of the finishing order determined in the processing (a); (d) determining whether the plurality of characters with the score provided correspond to members constituting any one of the plurality of teams, and whether all the members are characters to which the score is provided; (e) accumulating the score provided in the processing (c), for each of the teams wherein all the members thereof are characters to which the score is provided; (f) determining a ranking of the plurality of teams based on a sum total of the score obtained in the processing (e); and (g) providing an award based on any one of: the ranking of the plurality of characters and the ranking of the plurality of teams.

In the second aspect of the present invention, a controller of the gaming system has stored teams constituted of a predetermined number of characters in the first memory, which can be selected as a target of a bet by a player using the input device. To start a race, the controller firstly determines ranges of a finishing order to which a score, corresponding to the finishing order in a race, is provided and displays the same on the display. Subsequently, after receiving the bets from the plurality of terminals, the controller stores the bet kind and the bet amount in the second memory. Then the controller executes a race and tallies the result thereof. In other words, the controller provides a score to characters having finished within the predetermined range of finishing order. Then the controller determines a team to which the character, to which a score is provided, belongs and determines if all the members of the bet target teams are the characters to which a score is provided. Next, the controller accumulates the score, for each of the teams wherein all the members thereof are characters to which the score is provided. Then, the controller determines the ranking of the teams based on the accumulated score, and provides award depending on the bet kind and the bet amount made by each of the plurality of terminals, based on at least any one of the ranking of each of the plurality of characters and the ranking of each of the plurality of teams.

In a third aspect of the present invention, a gaming system includes: a display for displaying images related to a racing game in which a plurality of characters, which is a target of a bet, races; first memory for storing a plurality of teams constituted of a predetermined plurality of characters; a plurality of terminals including an input device for accepting a designation of at least any one of: a character as a target of a bet from the plurality of characters; and a team as a target of a bet from the plurality of teams stored in the first memory, and a predetermined bet amount; second memory for storing at least any one of the character and the team designated to be the target of a bet, and the bet amount for each of the plurality of terminals; third memory for storing a payout ratio table wherein a range of finishing order, to which a score, corresponding to a finishing order in a race, is provided, are associated with different odds; and a controller for executing the racing game, in which the controller executes the following processing of: (a) determining the range of finishing order based on the payout ratio table and displaying the range of finishing order and corresponding odds on the display; (b) determining odds for the plurality of teams participating in a race to be executed, based on the range of finishing order determined by the processing (a) and the payout ratio table stored in the third memory, and display the determined odds determined and the range of finishing order on the display; (c) receiving at least any one of the character and the team as a target of a bet, and the bet amount from the plurality of terminals and storing thereof in the second memory; (d) after a race, providing a score to characters having finished within the range of finishing order determined in the processing (a); (e) determining whether the plurality of characters, to which the score is provided, corresponds to members constituting any one of the plurality of teams, and whether all the members are characters to which the score is provided; (f) accumulating the score provided in the processing (d), for each of the teams wherein all the members thereof are characters to which the score is provided; (g) determining a ranking of the plurality of teams based on a sum total of the score obtained in the processing (f); and (h) providing at least any one of: an award based on the ranking of the plurality of teams and the odds determined in the processing (b); and an award based on the ranking of the plurality of characters.

In the third aspect of the present invention, a controller of the gaming system has stored teams constituted of a predetermined number of characters in the first memory, which can be selected as a target of a bet by a player using the input device. To start a race, the controller firstly determines a range of a finishing order to which a score, corresponding to the finishing order in a race, is provided and displays the ranges of finishing order and odds associated thereto, on the display. Different odds are associated with the ranges of finishing order. In other words, odds for teams are different according to the ranges of finishing order displayed. Subsequently, after receiving the bets from the plurality of terminals, the controller stores the bet kind and the bet amount in the second memory. Then the controller executes a race and tallies the result thereof. In other words, the controller provides a score to characters having finished within the predetermined range of finishing order. Then the controller determines a team to which the character, to which a score is provided, belongs and determines if all the members of the bet target teams are the characters to which a score is provided. Next, the controller accumulates the score, for each of the teams wherein all the members thereof are characters to which the score is provided. Then, the controller determines the ranking of the teams based on the accumulated score, and provides an award depending on the bet kind and the bet amount made by each of the plurality of terminals, based on at least any one of: the ranking of each of the plurality of characters; and the odds associated with the ranking of the teams and with the ranges of finishing order.

In a fourth aspect of the present invention, a gaming machine includes: a display for displaying images related to a racing game in which a plurality of characters, which is a target of a bet, races; first memory for storing a plurality of teams constituted of a predetermined plurality of characters; an input device for accepting a designation of the teams as a target of a bet from the plurality of the teams stored in the first memory, and a predetermined bet amount; second memory for storing the bet target team designated and the bet amount for each of the plurality of terminals; and a controller for executing the racing game, in which the controller executes the following processing of:(a) storing the bet target teams and the bet amount in the second memory; (b) after a race, providing a score, corresponding to a predetermined range of finishing order from a predetermined finishing order to a second predetermined finishing order, to each of the plurality of characters; (c) determining whether the plurality of characters with the score provided correspond to members constituting any one of the plurality of teams, and whether all the members are characters to which the score is provided; (d) accumulating the score provided in the processing (b), for each of the teams wherein all the members thereof are characters to which the score is provided; (e) determining a ranking of the plurality of teams based on a sum total of the score obtained in the processing (d); and (f) providing an award based on any one of: the ranking of the plurality of characters and the ranking of the plurality of teams.

In the fourth aspect of the present invention, the controller can handle the similar processing as disclosed in the first aspect.

In a fifth aspect of the present invention, a game control method for a gaming system including: first memory for storing a plurality of teams constituted of a predetermined plurality of characters as a target of a bet; an input device for accepting a designation of at least any one of: a character as a target of a bet from the plurality of characters, and a team as a target of a bet from the plurality of teams stored in the first memory, and a predetermined bet amount; and second memory for storing at least any one of the character and the team as a target of a bet, and the bet amount, in which the control method includes the following steps of: (a) storing at least any one of the character and the team as a target of a bet, and the bet amount for each of the plurality of terminals in the second memory; (b) after the end of a race, providing a score, corresponding to a predetermined range of a finishing order from a predetermined finishing order to a second predetermined finishing order, to each of the plurality of characters; (c) determining whether the plurality of characters with the score provided correspond to members constituting any one of the plurality of teams, and whether all the members are characters to which the score is provided; (d) accumulating the score provided in the processing (b), for each of the teams wherein all the members thereof are characters to which the score is provided; (e) determining a ranking of the plurality of teams based on a sum total of the score obtained in the processing (d); and (f) providing an award based on any one of: a ranking of the plurality of characters and a ranking of the plurality of teams.

In the fifth aspect of the present invention, the controller can handle the similar processing as disclosed in the first aspect.

### BRIEF DESCRIPTION OF THE DRAWINGS

FIG. 1 is a flow chart showing the main part of the present invention;

FIG. 2 is a perspective view showing the gaming system according to a preferred embodiment of the present invention;

FIG. 3 is a diagram showing the configuration of a gaming system according to a preferred embodiment of the present invention;

FIG. 4 is a block diagram of a main controller of the gaming system according to a preferred embodiment of the present invention;

FIG. 5 is a perspective view illustrating the terminal device according to the preferred embodiment of the present invention;

FIG. 6 is a block diagram showing an outline of the terminal device according to a preferred embodiment of the present invention;

FIG. 7 is a diagram showing the main flow chart of a gaming system according to a preferred embodiment of the present invention;

FIG. 8 is a flowchart showing bet target team determination processing of FIG. 7;

FIG. 9 is a diagram showing a bet target team determination table according to a preferred embodiment of the present invention;

FIG. 10 is a flowchart showing payout qualifying finishing order determination processing of FIG. 7;

FIG. 11 is a diagram showing a scoring finishing order/payout ratio determination table according to a preferred embodiment of the present invention;

FIG. 12 is a flowchart showing team result processing of FIG. 7;

FIG. 13 is a diagram showing a score table according to a preferred embodiment of the present invention;

FIG. 14 is a diagram showing a display example of the sub display device of the terminal device according to a preferred embodiment of the present invention; and

FIG. 15 is a display example of the main display device according to a preferred embodiment of the present invention.

### DETAILED DESCRIPTION OF THE INVENTION

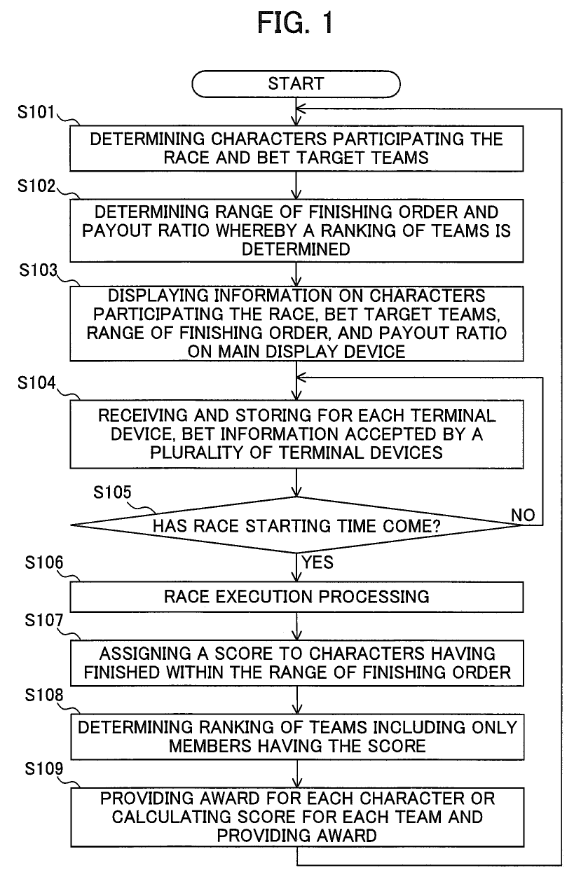

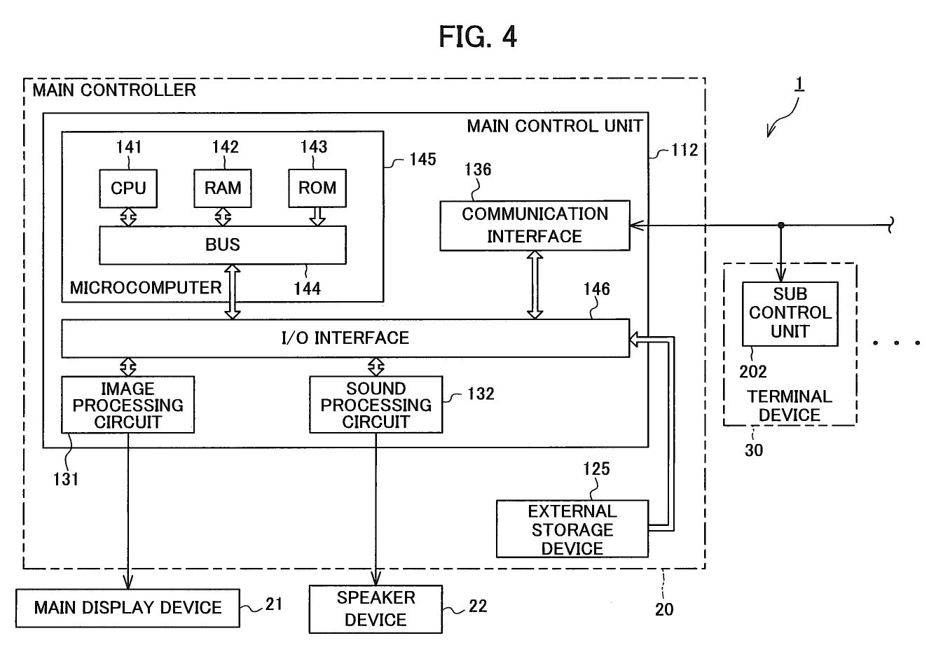

The main part of the present invention is described hereinafter with reference to FIG. 1. A main control unit 112 (see FIG. 4), of a main controller 20 controlling overall the gaming system 1 according to the present invention, determines a plurality of characters participating in a race and a plurality of teams as a target of a bet (step S101). In Step S102, the main control unit 112 determines ranges of finishing order of characters, that are used for determining ranking of teams after a race, and payout ratio (odds) for teams, and then advances to Step S103. In step S103, the main control unit 112 displays information about the plurality of characters and a plurality of teams determined to participate in a race, ranges of finishing order, and payout ratio of teams, on a main display device 21 and/or a sub display device 34 of terminal devices 30. In step S104, the main control unit 112 receives from a plurality of terminal devices 30 bet and bet amount accepted thereby, and stores the same, for each terminal device 30, in a predetermined storage region in RAM 142 (see FIG. 4) as second memory. In step S105, the main control unit 112 determines whether a bet accepting period has elapsed or not. YES for this determination leads to step S106 and NO for this determination leads to step S104. In step S106, a racing game is executed, then the flow advances to step S107. In Step S107, the main control unit 112 provides, based on the result of the racing game and the defined ranges of finishing order, a score to characters having finished within the ranges of finishing order, and then advances to Step S108. In Step S108, the main control unit 112 determines a ranking of teams including only members having a score, and then advances to Step S108. In step S109, the main control unit 112 determines award for each of the plurality of characters and provides award corresponding to the ranking of teams to each of the plurality of terminal devices 30, and then advances to Step S101.

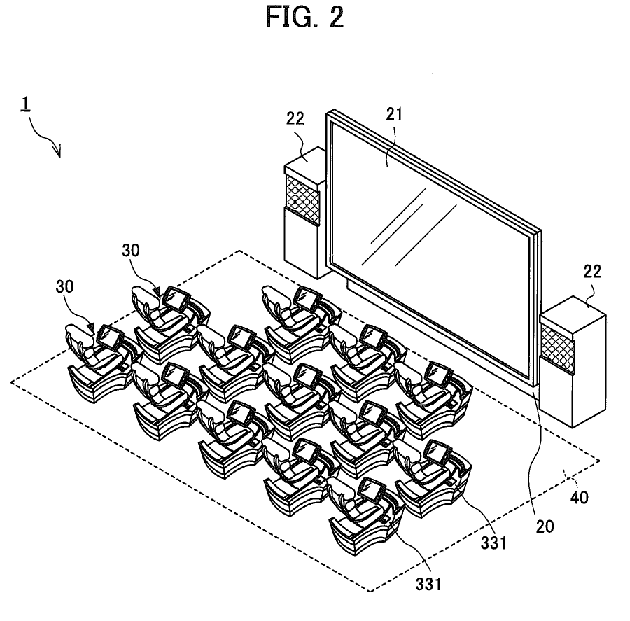

FIG. 2 is a perspective view showing an appearance of a gaming system 1 including a plurality of terminal devices 30. The gaming system 1 is a multi-player gaming system for a multi-player-type horse racing game, in which a plurality of players can participate, including a plurality of terminal devices 30 and a main controller 20, which is a controller having a large main display device 21.

The main controller 20 includes and controls the main display device 21 and speakers 22 installed on both sides of the main display device 21.

The main display device 21 is a large projector display device. The main display device 21 displays an image of a plurality of racehorses racing, a result of a race, and the like, in response to control by the main controller 20. On the other hand, a sub display device included in each terminal device 30 displays odds information for each racehorse, information related to a bet made by the player himself, and the like. It should be noted that a large projector display device is used in the present embodiment; however, the present invention is not limited thereto and any large monitor can be used.

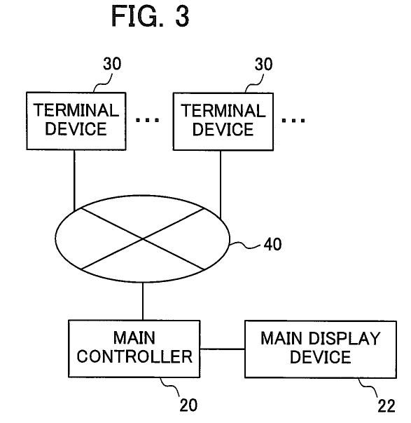

FIG. 3 is a schematic diagram showing a network of the gaming system 1.

In the gaming system 1, the main controller 20 and the plurality of terminal devices 30 can communicate with each other via a communication line and form a network 40. The main display device 21 is configured to be controlled from the main controller 20. The communication line can provide a wired or wireless connection.

FIG. 4 is a block diagram showing the configuration of a main control unit 112 included in the main controller 20. Basically, the main control unit 112 is constituted mainly of a microcomputer 145 constituted of a CPU 141, RAM 142, ROM 143, and a bus 144 for data transfer therebetween. The RAM 142 and the ROM 143 are connected to the CPU 141 via the bus 144. The RAM 142 is memory for temporarily storing various data computed by the CPU 141. The ROM 143 stores various programs for the operations required for the control of the gaming machine 1, data tables, and the like.

An image processing circuit 131 is connected to the microcomputer 145 via an I/O interface 146. The image processing circuit 131 is connected to the main display device 21 and controls the operation thereof.

The image processing circuit 131 is constituted of: program ROM; image ROM; an image control CPU; work RAM; a video display processor (VDP); video RAM (not shown); and the like. The program ROM stores an image control program and various selection tables related to the display on the main display device 21. The image ROM stores pixel data for forming an image, such as pixel data for forming an image on the main display device 21. The image control CPU determines an image to be displayed on the main display device 21 from pixel data prestored in the image ROM based on a parameter defined by the microcomputer 145 and in accordance with an image control program prestored in the program ROM. The work RAM functions as a temporary storage device for executing the image control program by the image control CPU. The VDP generates image data according to the display content determined by the image control CPU, and outputs thereof to the main display device 21. The video RAM functions as a temporary storage device to be used for forming an image by the VDP.

A sound circuit 132 is connected to the microcomputer 145 via the I/O interface 146. Speakers 22 are connected to the sound circuit 132. The speaker device 22 generates various sound effects, BGM and the like for implementing various effects, based on a driving signal from the CPU 141 and with an output control by the sound circuit 132.

An external storage device 125 is connected to the microcomputer 145 via the I/O interface 146. The external storage device 125 operates similarly to the image ROM in the image processing circuit 131, and pixel data for forming an image, such as pixel data for forming an image on the main display device 21, is stored therein. Therefore, the image control CPU in the image processing circuit 131 selects an image to be displayed on the main display device 21 also from pixel data prestored in the external storage device 125.

A communication interface 136 is connected to the microcomputer 145 via the I/O interface 146. A sub control unit 202 of each terminal device 30 is connected to the communication interface 136. This allows two-way communication between the CPU 141 and each terminal device 30. The CPU 141 can transmit and receive instructions, requests, data and the like with respect to each terminal device 30 via the communication interface 136. Therefore, the main controller 20 of the gaming system 1 controls the progress of a horse racing game, in cooperation with each terminal device 30.

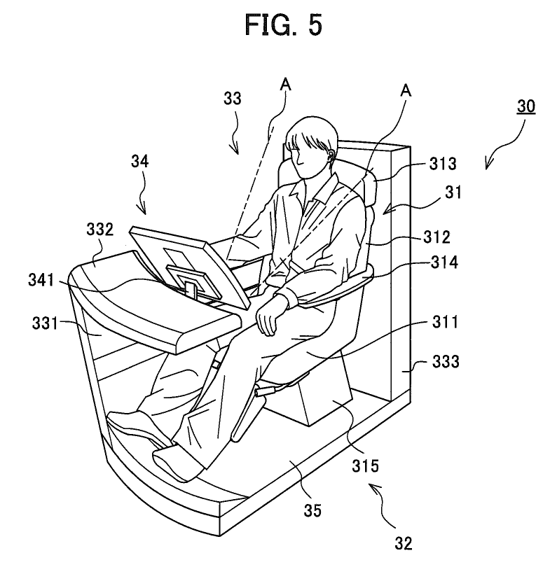

FIG. 5 is a perspective view showing an appearance of each terminal device 30. The terminal device 30 includes: a seat 31 on which a player can sit; an opening 32 formed on one of four lateral faces of the terminal device 30; a seat encircling portion 33 that covers three of four lateral faces of the terminal device 30 except for the lateral face having the opening 32; and a sub display device 34 installed on the seat encircling portion 33, in the front portion of the terminal device 30, that displays images related to the game.

The seat 31 includes: a seating surface 311 on which a player sits; a backrest 312 supporting the back of a player; a headrest 313 installed on top of the backrest 312; armrests 314 installed on both sides of the backrest 312; and a leg portion 315 fixed to the base portion 35.

The seat encircling portion 33 includes: a side unit 331 installed on an opposite face to the lateral face having the opening 32; a front unit 332 installed in the front portion of the terminal device 30; and a back unit 333 installed in the rear portion of the terminal device 30. This allows a player to sit on and get out of the seat 31 through the opening 32, in which the seat encircling portion 33 is not formed.

A medal slot into which medals corresponding to credits are inserted, a medal payout opening that pays out medals corresponding to credits, and the like are fixed on the side unit 331 (not shown). It should be noted that the gaming medium used in the present embodiment is medals; however, the present invention is not limited thereto. Examples of the gaming medium include coins, tokens, electronic money, or any equivalent valuable information such as electronic credit. In this case, credit can be paid out by a ticket printed out from a ticket printer 216 (described later).

The front unit 332 is a table having the base portion 35 and a substantially horizontal level surface, which is movably supported on the side unit 331, in the front portion of the terminal device 30. A player sitting on the seat 31 can put his legs into a space under the front unit 332.

The back unit 333 is integrated with the side unit 331 and constitutes a part of the seat encircling portion 33.

The sub display device 34 includes a supporting arm 341 supported by the front unit 332 and a rectangular liquid crystal monitor 342 for displaying, fixed at the distal end of the supporting arm 341. The liquid crystal monitor 342 is a so-called touch panel, and is provided at a position facing the chest of a player sitting on the seat 31. The liquid crystal monitor 342, which is a touch panel, serves as an input device used by a player to bet.

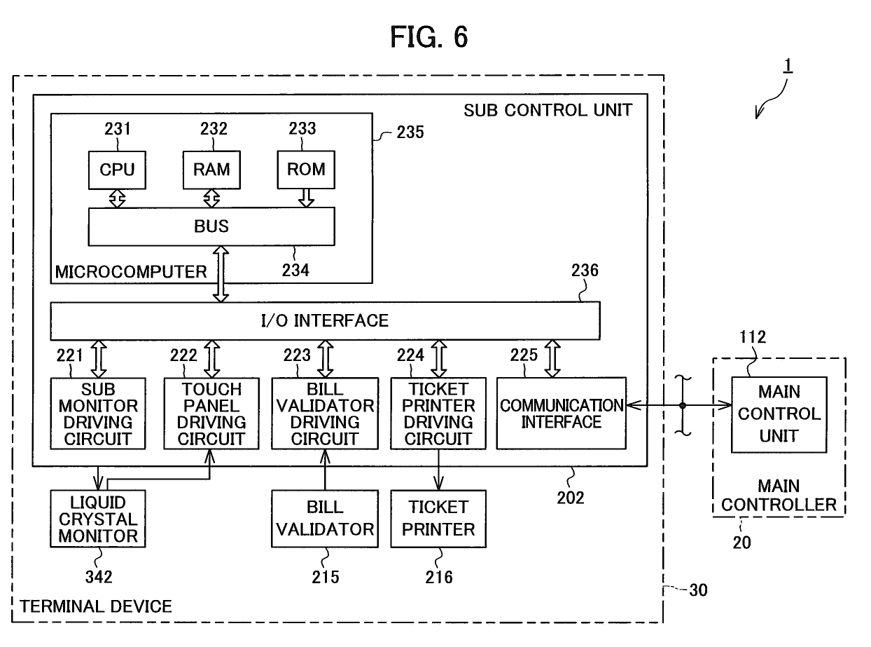

FIG. 6 is a block diagram showing the configuration of a sub control unit 202 included in the terminal device 30. The sub control unit 202 controls the terminal device 30 and basically is constituted mainly of a microcomputer 235 constituted of a CPU 231, RAM 232, ROM 233, and a bus 234 for data transfer therebetween. The RAM 232 and the ROM 233 are connected to the CPU 231 via the bus 234. The RAM 232 is memory for temporarily storing various data computed by the CPU 231. The ROM 233 stores various programs for the operations required for the control of the gaming system 1, data tables, and the like.

A sub monitor driving circuit 221 is connected to the microcomputer 235 via the I/O interface 236. A liquid crystal monitor 342 is connected to the sub monitor driving circuit 221. The sub monitor driving circuit 221 controls the operation of the liquid crystal monitor 342 based on a driving signal from a main controller 20.

A touch panel driving circuit 222 is connected to the microcomputer 235 via the I/O interface 146. A liquid crystal monitor 342 as a touch panel is connected to the touch panel driving circuit 222. An instruction, by a touching operation by a user, to the surface of the liquid crystal monitor 342 (touched position) is input to the CPU 231 based on a coordinate signal from the touch panel driving circuit 222.

A bill validator driving circuit 223 is connected to the microcomputer 235 via the I/O interface 236. A bill validator 215 is connected to the bill validator driving circuit 223. The bill validator 215 determines whether a bill or a bar coded ticket is valid or not. Upon reception of a valid bill, the bill validator 215 inputs the value thereof to the CPU 231 based upon the validating signal from the bill validator driving circuit 223. In addition, upon reception of a valid bar coded ticket, the bill validator 215 inputs the amount of the credit and the like recorded therein to the CPU 231 based upon the validating signal from the bill validator driving circuit 223.

A ticket printer driving circuit 224 is connected to the microcomputer 235 via the I/O interface 146. A ticket printer 216 is connected to the ticket printer driving circuit 224. With an output control by the ticket printer driving circuit 224 based on a driving signal output from the CPU 231, the ticket printer 216 prints a bar code on a ticket, on which data such as the credit amount stored in the RAM 232 are coded, and then prints out a bar coded ticket.

The communication interface 225 is connected to the microcomputer 235 via the I/O interface 236. The main control unit 112 of the main controller 20 is connected to the communication interface 225. This allows for two-way communication between the CPU 231 and the main control unit 112. The CPU 231 can transmit and receive instructions, requests, data and the like with respect to the main control unit 112 via the communication interface 225. Therefore, each terminal device 30 of the gaming system 1 controls the progress of a horse racing game, in cooperation with the main controller 20.

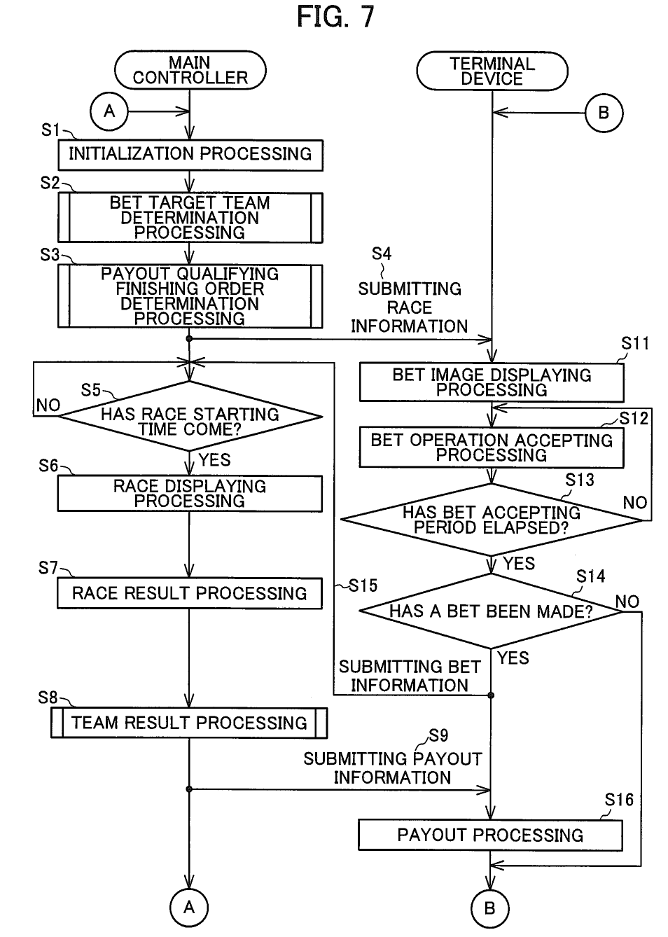

A flow of the operation of the gaming system 1 is explained hereinafter with reference to the flow chart shown in FIG. 7. It should be noted that all the terminal devices 30 similarly perform a game in cooperation with the main controller 20, although a single terminal device 30 is illustrated in FIG. 7.

The main controller 20 executes processing of Steps S1 to S9. Firstly, in Step Si, the main control unit 112 performs an initialization processing, and then advances to Step S2. In this processing, the CPU 141 determines a course of the race, characters participating in the race, the starting time and the like of the horse racing game, and reads data thereof from the ROM 143. In the present embodiment, all of the registered characters participate in the race.

In Step S2, the main control unit 112 performs bet target team determination processing, and then advances to Step S3. In the bet target team determination processing, a team as a target of a bet is determined based on the characters participating in the race, which are determined in Step Si. Details are described hereinafter.

In Step S3, the main control unit 112 performs a payout qualifying finishing order determination processing, and then advances to Step S4. This processing determines ranges of finishing order and payout ratio (odds), to be processed by a processing of determining a ranking of teams. Details are described hereinafter.

In Step S4, the main control unit 112 transmits race information to each of the terminal devices 30, and then advances to Step S3. In this processing, the CPU 141 transmits a course of the race, characters participating in the race, bet target teams, the starting time and the like, to each terminal device 30.

In Step S5, the main control unit 112 determines whether it is the starting time for the race. In a case where this determination is YES, the flow advances to Step S6, and in a case where this determination is NO, Step S5 is repeated. More specifically, the CPU 141 repeatedly checks the clock time until the time for starting the race comes, and, at the time for starting the race, advances to Step S6. It should be noted that in a case where bet information is received, the bet information is stored in a predetermined storage region in the RAM 142 for each terminal device 30. The bet information includes bet for each character, a bet for a team, and information regarding the bet amount thereof.

In Step S6, the main control unit 112 performs a race displaying processing, and then advances to Step S7. In this processing, the CPU 141 displays a race image on the main display device 21 and outputs sound effects and a voice from the speakers 22, based on data that is read from the ROM 143 in Step S1.

In Step S7, the main control unit 112 performs race result processing, and then advances to Step S8. In this processing, the CPU 141 computes the payout for each terminal device 30 based on the finishing order of the characters that participated in the race, data regarding bet information received from each terminal device 30, and the like.

In Step S8, the main control unit 112 performs a team result processing, and then advances to Step S9. In this processing, a ranking of teams is determined based on the finishing order of the characters participated in the race. Details are described hereinafter.

In Step S9, the main control unit 112 performs payout information transmission processing, and then advances to Step S1. In this processing, the CPU 141 transmits data regarding payout and the like computed in Steps S7 and S8 to the corresponding terminal device 30.

On the other hand, each terminal device 30 executes processing of Steps S11 to S16. Firstly, in Step S11, the sub control unit 202 performs bet image display processing, and then advances to Step S12. In this processing, the CPU 231 displays the odds for each racehorse, past records thereof and the like on the liquid crystal monitor 342, based on the data sent from the main controller 20 in Step S2.

In Step S12, the sub control unit 202 performs a bet operation accepting processing, and then advances to Step S13. In this processing, the CPU 231 enables touch operation by a player on the surface of the liquid crystal monitor 342 as a touch panel, starts accepting bet operations by the player, and changes images displayed thereon in accordance with the bet operation.

In Step S13, the sub control unit 202 determines whether a bet accepting period has elapsed or not. In a case where this determination is YES, the flow advances to Step S14, and in a case where this determination is NO, the flow advances to Step S12. More specifically, the CPU 231 repeatedly checks the clock time until a predetermined period has elapsed since the bet operation accepting processing is started in Step S12, and, once the predetermined period has elapsed, stop accepting bet operations by the player and advances to Step S14.

In Step S14, the sub control unit 202 determines whether a bet operation has been performed or not. If the determination is YES, the flow advances to Step S15, and if NO, the flow advances to Step S11. In this processing, the CPU 231 determines whether a bet operation has been performed in the abovementioned period in which the bet operation has been accepted.

In Step S15, the sub control unit 202 performs bet information transmission processing, and then advances to Step S16. In this processing, the CPU 231 transmits data regarding the performed bet operation to the main controller 20.

In Step S16, the sub control unit 202 performs payout processing, and then advances to Step S11. In this processing, the CPU 231 pays out medals from the medal payout opening, based on the data regarding payout and the like sent from the main controller 20 in Step S8.

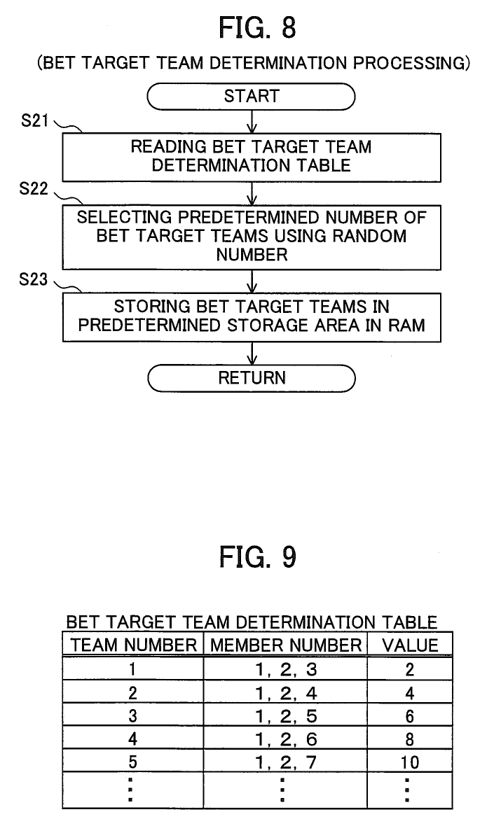

Bet target team determination processing is described with reference to FIG. 8.

In the bet target team determination processing, teams as the target of a bet are determined based on the characters participating in the race, which are determined in Step S1 of FIG. 7.

In Step S21, the main control unit 112 of the main controller 20 reads a bet target team determination table (later described in FIG. 9) from a predetermined storage region in the ROM 143, which is a first memory, and then advances to Step S22.

In Step S22, the main control unit 112 determines bet target teams by generating random numbers, and then advances to Step S23. In the processing of Step 22, a predetermined number of bet target teams are determined based on the bet target team determination table read in Step S21 and the generated random numbers. More specifically, the main control unit 112 generates the same number of random numbers as the number of bet target teams, and assigns a bet target team for each random number.

In Step S23, the main control unit 112 stores the bet target team as determined to the RAM 142, and then advances to Step S3 of FIG. 7.

FIG. 9 illustrates the bet target team determination table read in Step S21 and referenced in Step S22.

In the bet target team determination table, a team number, a member number and a value are correlated to each other. The team number is a serial number for each of the teams that can be bet target. The member number is a number of each character participating in the race. The member numbers in the same column belong to the same team. A team is formed of an arbitral number of characters. In the present embodiment, three characters comprise a team.

A team does not have duplicate characters. In other words, multiple identical characters cannot be members of the same team.

Identical characters can belong to different teams in one race. In other words, different teams can have the same character at once. For example, team numbers 2 and 4 in the bet target team determination table can be selected as a target of a bet in the same race. The team number 2 has characters of 1, 2, and 4 as members and the team number 4 has characters of 1, 2, and 6 as members. In this case, the characters 1 and 2 are members of different teams in the same race.

To select a team, the main control unit 112 generates the same number of random numbers as the number of teams as a target of a bet. In the present embodiment, the number of bet target teams is 6. In this case, the main control unit 112 generates 6 random numbers.

Subsequently, the main control unit 112 subtracts the value associated with the team, sequentially from team number 1, from the generated random number. In a case where the result is smaller than 0 (a negative number), the team having the value becomes a bet target team.

After the bet target team is thus determined for the first random number, a value is subtracted from the second random number, sequentially from the next row of the bet target team until a negative number is obtained. The main control unit 112 thus determines bet target teams for the 6 random numbers.

For example, in a case where one of the generated random numbers is 5, the main control unit 112 subtracts 2, associated with the team number 1, therefrom. The result is 3, which is a positive number. Subsequently, the main control unit 112 subtracts 4 in the next row from the result of the subtraction, 3. In this case, a negative number is obtained and the team number 2 becomes a bet target team for the random number 5. Next, the main control unit 112 subtracts a value associated with the team number 3 in the next row from the second random number.

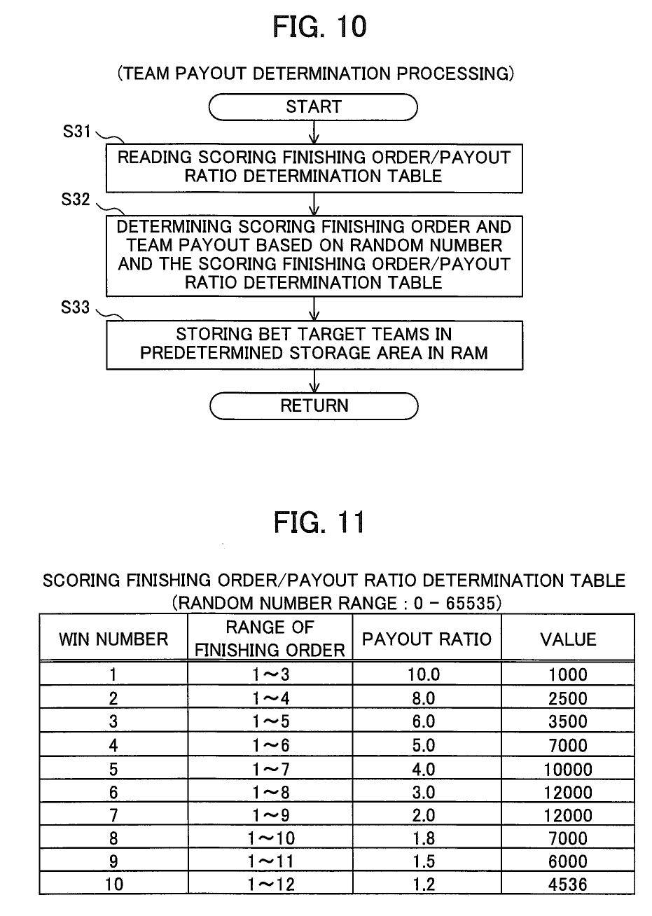

Team payout determination processing is described hereinafter with reference to FIG. 10. This processing determines ranges of finishing order and payout ratio, to be processed by a processing of determining a ranking of teams in Step S8 of FIG. 7.

In Step S31, the main control unit 112 reads a scoring finishing order/payout ratio determination table (later described in FIG. 11) from a predetermined storage region in the ROM 143, which is the third memory, and then advances to Step S32.

In Step S32, the main control unit 112 generates random numbers and references the scoring finishing order/payout ratio determination table to determine ranges of finishing order to which a score is provided and to determine a payout ratio thereof, and then advances to Step S33.

In Step S33, the main control unit 112 stores the ranges of finishing order and the payout ratio thereof being determined, to a predetermined storage region in the RAM 142, and then advances to Step S4 of FIG. 7.

The scoring finishing order/payout ratio determination table is described hereinafter with reference to FIG. 11. The table is read by the main control unit 112 in Step S31 of FIG. 10 and referenced in Step S32.

In the scoring finishing order/payout ratio determination table, a win number, a range of finishing order, a payout ratio, and a value are correlated to each other. The win number serves as a key to correlate the range of finishing order, the payout ratio, and the value registered in the same row in the table. The range of finishing order is a range of numerical value for identifying characters by which a ranking of teams is determined. For example, the range of finishing order “1-4” indicates a range from the first to the fourth place in a finishing order of a race.

A range of finishing order and a payout ratio to be selected by the main control unit 112 are determined based on a random number generated by the main control unit 112 and a value related to the range of finishing order and the payout ratio. The value is to be subtracted from a random value generated by the main control unit 112. A range of finishing order and a payout ratio, having in the same row a value that makes the random number negative as a result of the subtraction, is applied to an upcoming race executed by the main control unit 112.

For example, the main control unit 112 generates a random number 4000. Then a value related to the win number 1, 1000, is subtracted from the random number value. The result is 3000, a positive number. Subsequently, 2500, a value related to a win number 2, is subtracted from the result of the subtraction 3000. The result is 500, a positive number. Next, 3500, a value related to a win number 3, is subtracted from the result of the subtraction 500. The result is a negative number, thus the main control unit 112 selects a range of finishing order and a payout ratio related to the win number 3.

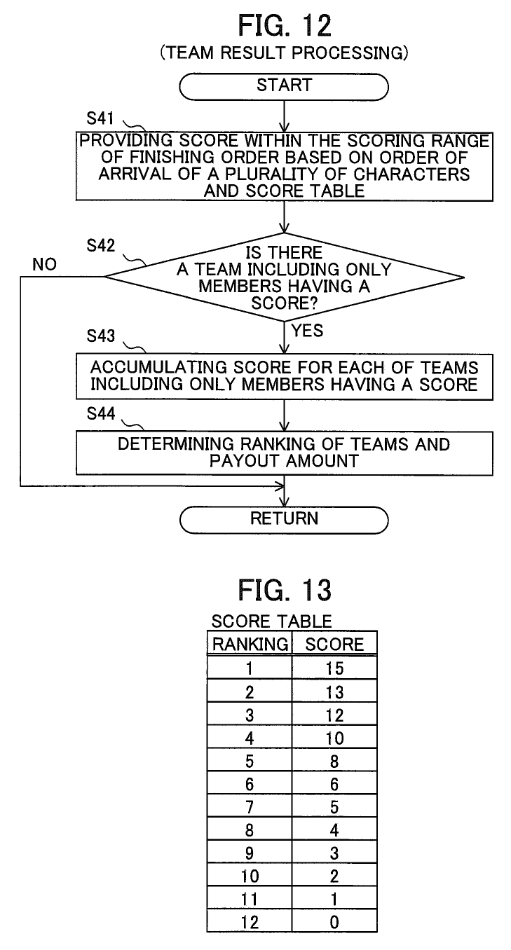

Team result processing is described hereinafter with reference to FIG. 12. The team result processing corresponds to Step S8 in FIG. 7.

First, in Step S41, the main control unit 112 provides a score corresponding to the ranking of characters to each character having finished within the determined range of finishing order, based on: the ranking of the characters participating in the race; the range of finishing order determined in Step S32 of FIG. 10; and a score table (described later in FIG. 13). Then the flow advances to Step S42.

In Step S42, the main control unit 112 determines whether there is a team, including only members having a score, in the bet target teams or not. YES for this determination leads to step S43 and NO for this determination leads to step S9.

In Step S43, the main control unit 112 accumulates the score provided to characters, for each of teams including only members having a score, and then advances to Step S44.

In Step S44, the main control unit 112 determines a payout based on the ranking of teams and the payout ratio determined in Step S32 of FIG. 10, and then advances to Step S9 of FIG. 7.

The score table is described hereinafter with reference to FIG. 13. The score table is a table referenced in Step S41 of FIG. 12.

In the score table, scores are associated with ranks. For example, the score for first place is 15. The score is thus provided to characters participating in the race according to the finishing order thereof.

In Step S41, the main control unit 112 sums the score for each team and the ranking of teams is determined. For example, in a case where the team number 2 is one of the bet target teams, the main control unit 112 sums the score of characters 1, 2, and 4, which are the members of the team number 2. For example, in a case where the character 1 takes first place, the character 2 takes fifth place and the character 4 takes tenth place, the score provided thereto is 15, 8, and 2, respectively. The sum total of the score is thus 25.

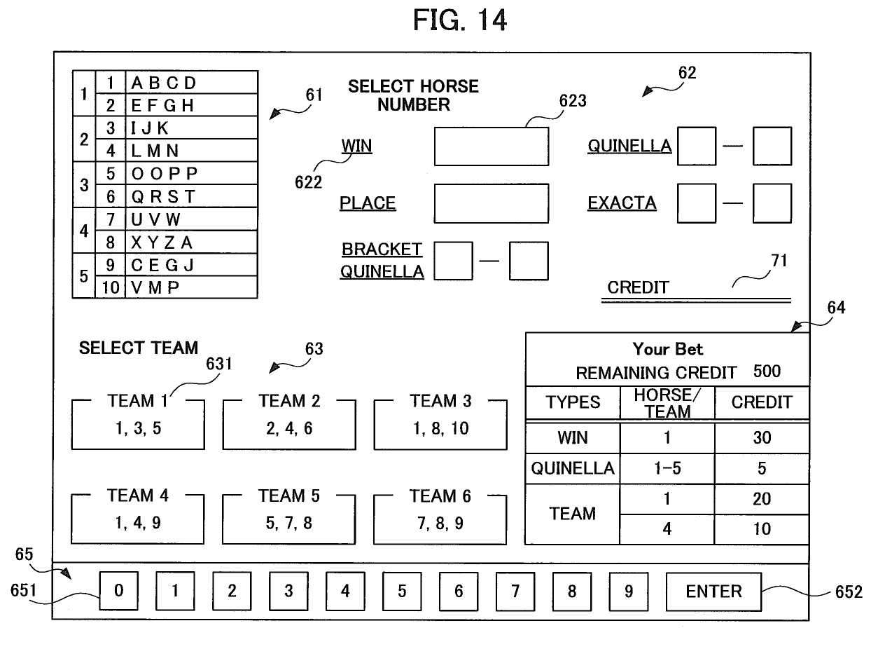

A display example of the bet window shown on the liquid crystal monitor 342 of the terminal device 30 is described hereinafter with reference to FIG. 14. The liquid crystal monitor 342 can be used as a touch panel, thus allowing a player to perform a bet operation by touching the touch panel according to the display thereon. In other words, the liquid crystal monitor and the touch panel are an input device of the terminal device 30.

The bet window is divided into 5 areas in the display example of FIG. 14. The first area 61 displays the character number, the post position, the character name and the like of the characters participating in the race. A player can select the character to bet on with reference thereto.

The second area 62 is an area for betting. An input area is provided for each bet type that can be chosen in the racing game. The bet types can include any bet type that can be chosen in the normal horse racing games, such as Win (to predict a character for the first place) and Quinella (to predict a combination of characters for the first and second places). To input, a player touches a bet type to make the bet type be in a selected state. Subsequently, a player touches a character number or a character name displayed on the first area 61 to bet thereon. For example, to make a Win bet, a player firstly touches an item 622 “Win”, and then touches a character number or a character name displayed on the first area 61. This inputs the character number touched by a player in a column 623.

The third area 63 is an area for betting on teams. Bet target teams and character number of members thereof are displayed on the third area. For example, a team 1 has character numbers 1, 3, and 5 as members. 6 bet target teams are thus displayed in the present embodiment. In a case of betting on a team, a player can specify a bet target by touching an area 631, in which a team to bet on is displayed.

The fourth area 64 displays a list of bets made by a player. A player can check the bets he made and the remained credit by looking at the fourth area 64.

The fifth area 65 is the numerical pad area. A player inputs bet amount in the fifth area 65. A player can input a bet amount by touching an ante input area 71, and then each number key 651 displayed in a numerical pad area 65. A player can confirm the input numerical value by touching an input key 652.

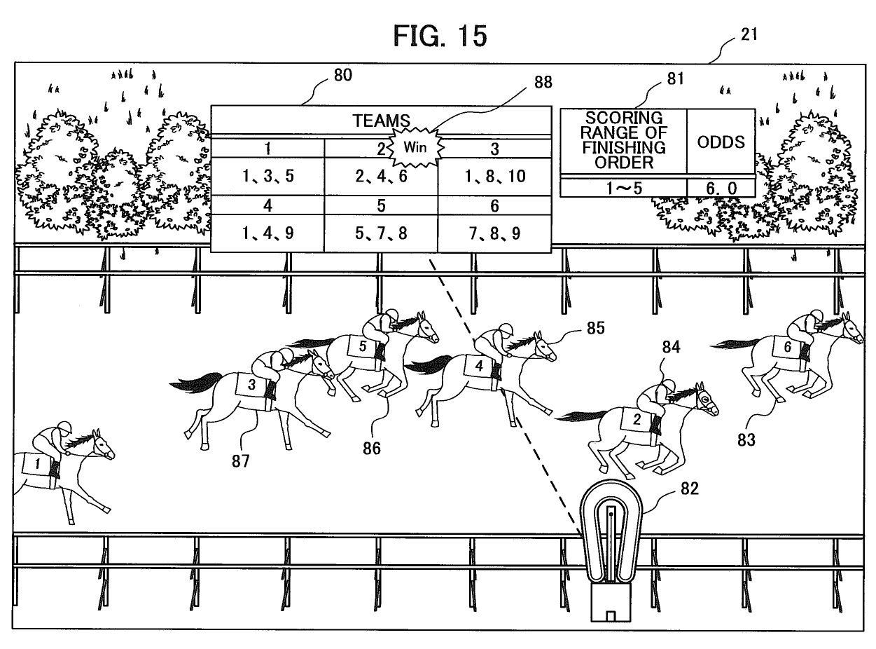

A display example of the main display device 21 is described with reference to FIG. 15. The display example of in FIG. 15 shows the display at the last minute of a racing game. More specifically, the display example shows a finishing scene of a race.

According to FIG. 15, a table 80 showing bet target teams and members thereof, and a table 81 showing payout ratio and range of finishing order, for a case where a player wins a bet, are displayed. Here, a character 83 (number 6), a character 84 (number 2), and a character 85 (number 4) have passed through a finish line 82 in the race. Therefore, the main control unit 112 firstly provides score for the characters 83, 84 and 85. Scoring finishing order is the first to the fifth places. Thus the main control unit 112 provides score for the characters of first place to the fifth place (Step S41 of FIG. 12). Here, a character 86 (number 5) is in the fourth place and a character 87 (number 3) is in the fifth place.

Subsequently, the main control unit 112 determines whether there is a team, including only members having a score, in the bet target teams or not (Step S42 of FIG. 12), and then correct the score for such teams. Here, the members of the team 2 are all provided with a score; however, the members of other teams are not all provided with a score. Therefore, in this example, only the score for the team 2 is corrected and the team 2 is at the top of the ranking of teams. In FIG. 15, a symbol 88 showing the winning team is displayed in the table 80.

In the present embodiment, the bet target of the racing game includes teams, in addition to characters. In other words, even if one single character arrives early, a prize is not necessarily provided. Whether a prize is provided or not is determined in relation to the finishing order of other characters. This can provide a larger number of kinds of bets, whereby various bet types are provided having a higher chance of being rewarded, thus arousing interest and excitement of the player.

In the present embodiment, a player can bet on teams constituted of a predetermined plurality of characters, in addition to a ranking of characters; however, the present invention is not limited thereto. For example, a configuration allowing only betting on teams is also possible. In addition, the number of members of a team is 3 in the present embodiment; however, the present invention is not limited thereto and a team can have less or more members.

In the present embodiment, values to be subtracted from the random number generated by the main control unit 112 are defined in the bet target team determination table and the scoring finishing order/payout ratio determination table; however, the present invention is not limited thereto, and ranges can be defined for random numbers generated. In other words, in a case where a certain random number is within a certain range, a team with a team number associated with the range is selected as a bet target team (bet target team determination table), and the range of finishing order and the payout ratio associated with the range is selected (the scoring finishing order/payout ratio determination table).

In the present embodiment, a higher score is provided to a character of a higher rank, and the team having the higher sum total of score is ranked higher; however, the present invention is not limited thereto. For example, a lower score can be assigned to a character of a higher rank, and the team having the lower sum total of score can be ranked higher.

In the present embodiment, the range of finishing order for determining a ranking of teams is, according to the scoring finishing order/payout ratio determination table, from first place to a predetermined place; however, the present invention is not limited thereto. For example, the range can be, not only from first place, but from a certain place to another certain place. More specifically, a range from second to fifth place and a range from third to tenth place can also be selected as the range.

In the present embodiment, all the registered characters participate in the race; however, the present invention is not limited thereto. For example, a larger number of characters can be registered than a number of characters participating in the race, and the characters participating in the race can be selected therefrom. In this case, in the processing of selecting bet target teams, teams including only characters participating in the race can be selected. In other words, for example, a flag can be set to teams including only characters participating in the race, and the bet target teams can be selected therefrom by random number lottery.

In the present embodiment, a bet can be made to a team of first place; however, the present invention is not limited thereto. For example, as in the bet on characters, a bet can be made on a combination of teams in the first and the second places, or a bet can be made by predicting the ranking of characters in a selected team.

It should be noted that the gaming system includes the main display device 21 that is installed so as to be visible from a plurality of the terminal devices 30, in the present embodiment; however, the present invention is not limited thereto. For example, the network 40 can be expanded worldwide without providing the main display device 21. In this case, in addition to information displayed on the sub display device, a race image and a race result image, displayed on the main display 21 in the present embodiment, should be displayed on each of the plurality of terminal devices 30.

It should be noted that the gaming medium used in the present embodiment is medals; however, the present invention is not limited thereto. Examples of the gaming medium include coins, tokens, electronic money, or any equivalent valuable information such as electronic credit.

While the preferred embodiment of the present invention has been described above, it is apparent to one skilled in the art that various changes and modifications can be made without departing from the scope of the claims appended to this specification.

What is claimed is:

1. A gaming system comprising:
a display for displaying images related to a racing game in which a plurality of characters, which is a target of a bet, races;
first memory for storing a plurality of teams constituted of a predetermined plurality of characters;
a plurality of terminals comprising an input device for accepting a designation of the teams as a target of a bet from a plurality of the teams stored in the first memory, and a predetermined bet amount;
second memory for storing a designated bet target team and the bet amount for each of the plurality of terminals; and
a controller for executing the racing game,
wherein the controller executes processing of:
(a) receiving the bet target team and the bet amount from the plurality of terminals and storing thereof, for each of the plurality of terminals, in the second memory;
(b) after the end of a race, providing a score, corresponding to a predetermined range of a finishing order from a predetermined finishing order to a second predetermined finishing order, to each of the plurality of characters;
(c) determining whether the plurality of characters, to which the score is provided, correspond to members constituting any one of the plurality of teams, and whether all the members are characters to which the score is provided;
(d) accumulating the score provided in the processing (b), for each of the teams wherein all the members thereof are characters to which the score is provided;
(e) determining a ranking of the plurality of teams based on a sum total of the score obtained in the processing (d); and
(f) providing an award based on the ranking of the plurality of teams.

2. A gaming system comprising:
a display for displaying images related to a racing game in which a plurality of characters, which is a target of a bet, races;
first memory for storing a plurality of teams constituted of a predetermined plurality of characters;
a plurality of terminals comprising an input device for accepting a designation of at least any one of:
a character as a target of a bet from the plurality of characters; and
a team as a target of a bet from the plurality of teams stored in the first memory, and a predetermined bet amount;
second memory for storing at least any one of the character and the team designated to be the target of the bet, and the bet amount for each of the plurality of terminals;
third memory for storing a range table defining a plurality of ranges of a finishing order to which a score, corresponding to the finishing order in a race, is provided; and
a controller for executing the racing game, wherein the controller executes processing of:
(a) determining the range of the finishing order to be applied to a race to be executed based on the range table stored in the third memory, and displaying thereof on the display;
(b) receiving at least any one of the character and the team as a target of a bet, and the bet amount from the plurality of terminals and storing thereof in the second memory;
(c) after the end of a race, providing a score to characters having finished within the range of the finishing order determined in the processing (a);
(d) determining whether the plurality of characters, to which the score is provided, correspond to members constituting any one of the plurality of teams, and whether all the members are characters to which the score is provided;
(e) accumulating the score provided in the processing (c), for each of the teams wherein all the members thereof are characters to which the score is provided;
(f) determining a ranking of the plurality of teams based on a sum total of the score obtained in the processing (e); and
(g) providing an award based on any one of: the ranking of the plurality of characters and the ranking of the plurality of teams.

3. A gaming system comprising:
a display for displaying images related to a racing game in which a plurality of characters, which is a target of a bet, races;
first memory for storing a plurality of teams constituted of a predetermined plurality of characters;
a plurality of terminals comprising an input device for accepting a designation of at least any one of: a character as a target of a bet from the plurality of characters; and
a team as a target of a bet from the plurality of teams stored in the first memory, and a predetermined bet amount;
second memory for storing at least any one of the character and the team designated to be the target of a bet, and the bet amount for each of the plurality of terminals;
third memory for storing a payout ratio table wherein a range of finishing order, to which a score, corresponding to a finishing order in a race, is provided, are associated with different odds; and
a controller for executing the racing game, wherein the controller executes processing of:
(a) determining the range of finishing order based on the payout ratio table and displaying the range of finishing order and corresponding odds on the display;
(b) determining odds for the plurality of teams participating in a race to be executed, based on the range of finishing order determined by the processing (a) and the payout ratio table stored in the third memory, and display the odds determined and the range of finishing order on the display;
(c) receiving at least any one of the character and the team as a target of a bet, and the bet amount from the plurality of terminals and storing thereof in the second memory;
(d) after a race, providing a score to characters having finished within the range of finishing order determined in the processing (a);
(e) determining whether the plurality of characters, to which the score is provided, corresponds to members constituting any one of the plurality of teams, and whether all the members are characters to which the score is provided;
(f) accumulating the score provided in the processing (d), for each of the teams wherein all the members thereof are characters to which the score is provided;
(g) determining a ranking of the plurality of teams based on a sum total of the score obtained in the processing (f); and
(h) providing at least any one of: an award based on the ranking of the plurality of teams and the odds determined in the processing (b); and
an award based on the ranking of the plurality of characters.

4. A gaming machine comprising:
a display for displaying images related to a racing game in which a plurality of characters, which is a target of a bet, races;
first memory for storing a plurality of teams constituted of a predetermined plurality of characters;
an input device for accepting a designation of the teams as a target of a bet from the plurality of the teams stored in the first memory, and a predetermined bet amount;
second memory for storing the bet target team designated and the bet amount for each of the plurality of terminals; and
a controller for executing the racing game,
wherein the controller executes processing of:
(a) storing the bet target teams and the bet amount in the second memory;
(b) after a race, providing a score, corresponding to a predetermined range of finishing order from a predetermined finishing order to a second predetermined finishing order, to each of the plurality of characters;
(c) determining whether the plurality of characters with the score provided correspond to members constituting any one of the plurality of teams, and whether all the members are characters to which the score is provided;
(d) accumulating the score provided in the processing (b), for each of the teams wherein all the members thereof are characters to which the score is provided;
(e) determining a ranking of the plurality of teams based on a sum total of the score obtained in the processing (d); and
(f) providing an award based on any one of: the ranking of the plurality of characters and the ranking of the plurality of teams.

5. A game control method for a gaming system comprising:
first memory for storing a plurality of teams constituted of a predetermined plurality of characters as a target of a bet;
an input device for accepting a designation of at least any one of:
a character as a target of a bet from the plurality of characters, and a team as a target of a bet from the plurality of teams stored in the first memory, and a predetermined bet amount; and
second memory for storing at least any one of the character and the team as a target of a bet, and the bet amount,
wherein the control method comprises the following steps of:
(a) storing at least any one of the character and the team as a target of a bet, and the bet amount for each of the plurality of terminals in the second memory;
(b) after the end of a race, providing a score, corresponding to a predetermined range of a finishing order from a predetermined finishing order to a second predetermined finishing order, to each of the plurality of characters;
(c) determining whether the plurality of characters with the score provided correspond to members constituting any one of the plurality of teams, and whether all the members are characters to which the score is provided;
(d) accumulating the score provided in the processing (b) for each of the teams wherein all the members thereof are characters to which the score is provided;
(e) determining a ranking of the plurality of teams based on a sum total of the score obtained in the processing (d); and
(f) providing an award based on any one of: a ranking of the plurality of characters and a ranking of the plurality of teams.
